(19) United States
(12) Patent Application Publication
(10) Pub. No.: US 2007/0137473 A1
(43) Pub. Date: Jun. 21, 2007

(54) Actuation unit for a hydraulic vehicle brake

(75) Inventor: Stefan A. Drumm, Saulheim (DE)

Correspondence Address: CONTINENTAL TEVES, INC., ONE CONTINENTAL DRIVE, AUBURN HILLLS, MI, 48326-1581, US

(73) Assignee: Continental Teves AG & Co. oHG

(21) Appl. No.: 10/569,007

(22) PCT Filed: Aug. 20, 2004
(86) PCT No.: PCT/EP04/51873

§ 371 Date: Dec. 4, 2006

(30) Foreign Application Priority Data
Aug. 20, 2003 (DE) 10338855.9

(51) Int. Cl. F15B 9/10

(52) U.S. Cl. 91/376 R

(57) ABSTRACT

The invention relates to an actuation unit for a hydraulic vehicle brake system, comprising a pneumatic brake booster and a master brake cylinder connected downstream of the pneumatic brake booster, with the pneumatic brake booster, in a booster housing, having a first movable wall and a second movable wall being in a force-transmitting connection to a piston of the master brake cylinder, with the movable walls delimiting a working chamber which can be evacuated or aerated by means of a control group that is composed of a vacuum sealing seat, an atmospheric sealing seat, and a valve member cooperating with the sealing seats.

### BACKGROUND OF THE INVENTION

The present invention relates to an actuation unit for a hydraulic vehicle brake system, comprising a pneumatic brake booster and a master brake cylinder connected downstream of the pneumatic brake booster, with the pneumatic brake booster, in a booster housing, having a first movable wall and a second movable wall being in a force-transmitting connection to a piston of the master brake cylinder, with the movable walls delimiting a working chamber which can be evacuated or aerated by means of a control group that is composed of a vacuum sealing seat, an atmospheric sealing seat, and a valve member cooperating with the sealing seats.

German published application DE 36 41 105 A1 discloses an actuation unit of this type for use in a hydraulic vehicle brake system. A vacuum sealing seat is designed in a control housing accommodating a control group in the prior art actuation unit. The control housing is guided in a booster housing in a slidable and sealed manner. An atmospheric sealing seat is integrally designed with a valve piston which is coupled to a pedal movement by way of a piston rod and is displaceable in the control housing. A first movable wall is attached to a cylindrical component being, in turn, used to guide the control housing. The pneumatic sealing between the control housing and the booster housing is achieved by a seal in the prior art actuation unit. It is disadvantageous in this arrangement that, upon actuation of the control group, the above-mentioned seal generates friction which impairs the response characteristic of the actuation unit.

### SUMMARY OF THE INVENTION

Hence, an object of the invention is to simplify an actuation unit of the type initially referred to in such a manner that seals are economized in order to improve the response characteristic and the dynamics of the actuation unit.

According to the invention, this object is achieved in that the vacuum sealing seat is in operative engagement with the booster housing, while the atmospheric sealing seat is in operative engagement with the first movable wall.

It is then arranged for that the frictional connection between the vacuum sealing seat and the booster housing is established by means comprising at least one stop and an electrically controllable stroke actuator.

Besides, the frictional connection between the atmospheric sealing seat and the first movable wall is established by a fixed coupling or a direct mechanical contact of the mentioned components.

In a particularly favorable improvement of the subject matter of the invention, an additional atmospheric sealing seat is provided which interacts with an additional valve member and becomes active when the control group is quickly actuated. As this occurs, the frictional connection between the atmospheric sealing seat and the first movable wall occurs by way of the additional sealing seat.

In an especially advantageous embodiment, a movement of the vacuum sealing seat is coupled to the movement of an armature of the electrically controllable stroke actuator which, in the event of an actuation stroke, closes the vacuum sealing seat by abutment on the valve member and opens the atmospheric sealing seat by lifting the valve member.

The electrically controllable stroke actuator is arranged in an immovable way relative to the booster housing in another favorable embodiment.

An improvement of the subject matter of the invention provides that the movement of at least one atmospheric sealing seat is coupled to the movement of the first movable wall.

In a particularly advantageous embodiment, a brake pedal travel simulation device is provided, comprising resilient and/or damping and/or frictional elements. In this arrangement, the brake pedal travel simulation device is accommodated in a cylindrical component which is connected to the first movable wall and carries one of the atmospheric sealing seats.

Further, a pneumatic vacuum chamber is provided in the booster housing, extending into the area of the control group and being connectible to the working chamber.

In another favorable embodiment of the subject matter of the invention, pneumatic sealants are provided between the booster housing and the movable parts of the control group or between these, the sealants being configured as pleated bellows or hose collars.

It is arranged for that the resilient and/or damping and/or frictional elements are arranged between the first movable wall and a piston rod actuating the control group in terms of force transmission.

In a favorable improvement of the subject matter of the invention, at least two tensile-force transmitting elements are provided which extend through the booster housing and are used to attach the master brake cylinder to the booster housing, on the one hand, and to mount the actuation unit on a splashboard of the vehicle, on the other hand.

There is further provision of a disengaging sleeve which is slidingly arranged in the booster housing in a pneumatically seal-tight manner and is connected to the first movable wall by way of a rolling diaphragm.

In a particularly favorable embodiment, it is provided that the brake pedal travel simulation device can be disabled in terms of effect. It is arranged for that the brake pedal travel simulation device is disabled in terms of effect depending on the travel of the first movable wall relative to the booster housing.

### BRIEF DESCRIPTION OF THE DRAWINGS

The invention will be explained in detail in the following by way of two embodiments making reference to the accompanying drawings. In the drawings:

FIG. 1 is a schematic axial cross-sectional view of a first design of the actuation unit of the invention in the non-actuated condition;

FIG. 2 is a schematic view of a second design of the actuation unit of the invention in the non-actuated condition.

### DETAILED DESCRIPTION OF THE DRAWINGS

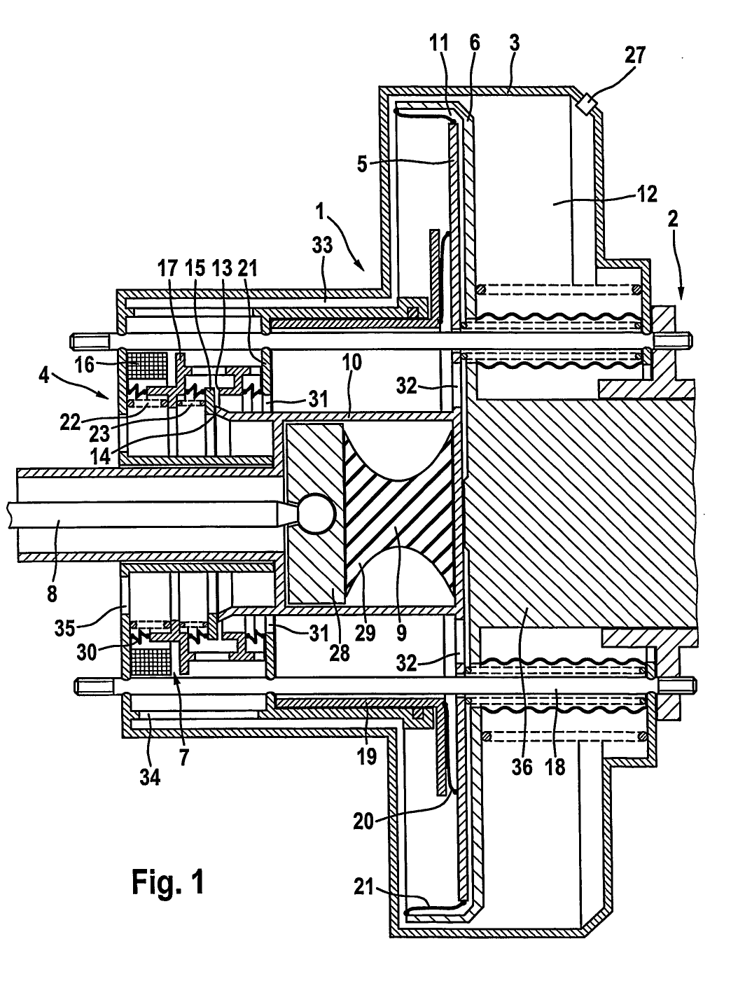

The actuation unit of the invention for use in a hydraulic vehicle brake system, which is only represented in FIG. 1, includes a pneumatic brake booster 1 being connected to a brake pedal (not shown) by way of a piston rod 8. On the side of the pneumatic brake booster 1 remote from the piston rod 8, a master brake cylinder 2, which is shown only in part in FIG. 1, is connected downstream of the pneumatic brake booster 1.

As illustrated in FIG. 1, the pneumatic brake booster 1 houses in a booster housing 3 a first and a second movable wall 5, 6, the second movable wall 6 being in a force-transmitting connection with a piston (not shown) of the master brake cylinder 2 by way of a force-transmitting member 36. The two movable walls 5, 6 delimit jointly a working chamber 11 and are pressure-tightly interconnected for this purpose by way of a rolling diaphragm 21. The working chamber 11 is connectible to a pneumatic chamber 12 designed in the booster housing 3 by way of openings 32, 31, a control group 4 which will be explained in detail in the following, a housing aperture 34 and a vacuum channel 33. Further, the working chamber 11 is connectible to the atmosphere by way of the control group 4 mentioned before and by way of additional housing apertures 35. As the above-mentioned pneumatic chamber 12 is connected to a vacuum source (not shown) by way of a vacuum connection 27 in the booster housing 3, the working chamber 11 can be evacuated by connecting to the pneumatic chamber 12 and aerated by connecting to the atmosphere.

In addition, the actuation unit of the invention includes two tensile-force transmitting elements 18 which extend through the booster housing 3. These tensile-force transmitting elements 18 are used to attach the master brake cylinder 2 to the booster housing 3, on the one hand, and to mount the actuation unit of the invention on a splashboard of the vehicle, on the other hand.

The piston rod 8 which is connected to the brake pedal (not shown) extends into the booster housing 3 and is supported on a cylindrical component 10, which is rigidly connected to the first movable wall 5, by way of a force-transmitting plate 28 and a brake pedal travel simulation device 9, the function of which will be explained in detail later on. The cylindrical component 10 carries an atmospheric sealing seat 14 which cooperates with an annularly designed valve member 15. Also cooperating with this valve member 15 is a vacuum sealing seat 13 which is designed at an armature 17 of an electrically controllable stroke actuator 7. In the embodiment shown in FIG. 1, the electrically controllable stroke actuator 7 is designed as an electromagnet provided with a coil 16 which is immovably arranged in the booster housing 3. The mentioned armature 17, under the effect of the force of a spring 22, bears against a stop 21 designed in the booster housing 3. Intermediate the booster housing 3 and the armature 17, intermediate the armature 17 and the valve member 15, as well as intermediate the armature 17 and the stop 21, pneumatic seals are provided which are configured as pleated bellows made of rubber or any similar material in the embodiment shown in FIG. 1. Alternatively, hose collars are also feasible as pneumatic seals of the described elements of the control group 4.

It is obvious due to the described structure of the control group 4 that the vacuum sealing seat 13 is in operative engagement with the booster housing 3 and the atmospheric sealing seat 14 is in operative engagement with the first movable wall 5. The operative engagement between the vacuum sealing seat 13 and the booster housing 3 is achieved by way of the stop 21 designed in the booster housing 3, on the one hand, and by way of the coil 16 of the electromagnet arranged on the housing, on the other hand. The operative engagement between atmospheric sealing seat 14 and first movable wall 5 is achieved by the above-mentioned rigid connection between the cylindrical component 10, which carries the atmospheric sealing seat 14, and the first movable wall 5. The movement of the atmospheric sealing seat 14 is thus likewise coupled to the movement of the first movable wall 5.

The above-mentioned cylindrical component 10 which is connected to the first movable wall 5 is also connected to a disengaging sleeve 19 in a pneumatically seal-tight manner by way of a rolling diaphragm 21, and the function of the sleeve will be explained more closely. The disengaging sleeve 19 is arranged in the booster housing 3 in a pneumatically seal-tight and sliding fashion.

The function of the actuation unit of the invention will be described in the following:

In the non-actuated condition of the pneumatic brake booster 1, the vacuum seat 13 is opened and the atmospheric sealing seat 14 closed, while both the pneumatic chamber 12 and the working chamber 11 are evacuated. This condition is illustrated in FIG. 1. Upon actuation of the brake pedal (not shown), the piston rod 8, by way of the force-transmitting plate 28 and the brake pedal travel simulation device 9, moves the cylindrical component 10 and, hence, the first movable wall 5 to the right in the drawing. In consequence of this displacement, the vacuum sealing seat 13 is closed because the valve member 15 that is biased by a spring 23 moves into abutment on the vacuum seat. Further, the atmospheric sealing seat 14 detaches from the valve member abutted on the vacuum sealing seat 13, whereupon outside air under atmospheric pressure can flow through the openings 31, 32 into the working chamber 11. The difference in pressure between the working chamber 11 and the pneumatic chamber 12 will now bring about a force application on the second movable wall 6 and, hence, a force application on the master brake cylinder 2 by way of the force-transmitting member 36, with the result of providing hydraulic pressure that is necessary for actuating wheel brakes, and the related displacement travel.

Simultaneously, the difference in pressure brings about that the first wall 5 is shifted to the left in the drawing and the atmospheric sealing seat 14 is closed again, if a balance has developed between the actuating force of the piston rod 8 and the counteracting force on the first wall 5. The actuating travel of the piston rod 8 to the right in the drawing is received by the pedal travel simulation device 9 which contains a resilient and/or a damping element 29 for this purpose. In addition, frictional elements can be used to achieve pleasant pedal characteristics. The elements 29 mentioned before are hence arranged in the frictional connection between the piston rod 8 and the first movable wall 5.

The working chamber 11 is aerated again in the event of a continued displacement of the piston rod 8 due to a continued actuation of the pneumatic brake booster 1. When the actuation of the pneumatic brake booster 1 is terminated, the vacuum sealing seat 13 will be opened, and the working chamber 11 is connected to the pneumatic chamber 12 through the opened vacuum sealing seat 13, the housing aperture 34, and the vacuum channel 33, whereby the working chamber 11 is evacuated.

Furthermore, the actuation unit of the invention can be activated independently, i.e. an actuation can be performed independently of the direct wish from the driver or superposed on a braking operation initiated by the driver. The electrically controllable stroke actuator 7 that is designed as an electromagnet is mainly provided to this end, the coil 16 of which pulls the armature 17 to the left in FIG. 1 when energized accordingly. As this occurs, initially the vacuum sealing seat 13 is closed because it moves into abutment on the valve member 15. Subsequently, the armature 17 lifts the valve member 15 from the atmospheric sealing seat 14 in opposition to the effect of the spring 23, and opens said. In turn, this causes the working chamber 11 to be aerated, as described before, and the master brake cylinder 2 actuated.

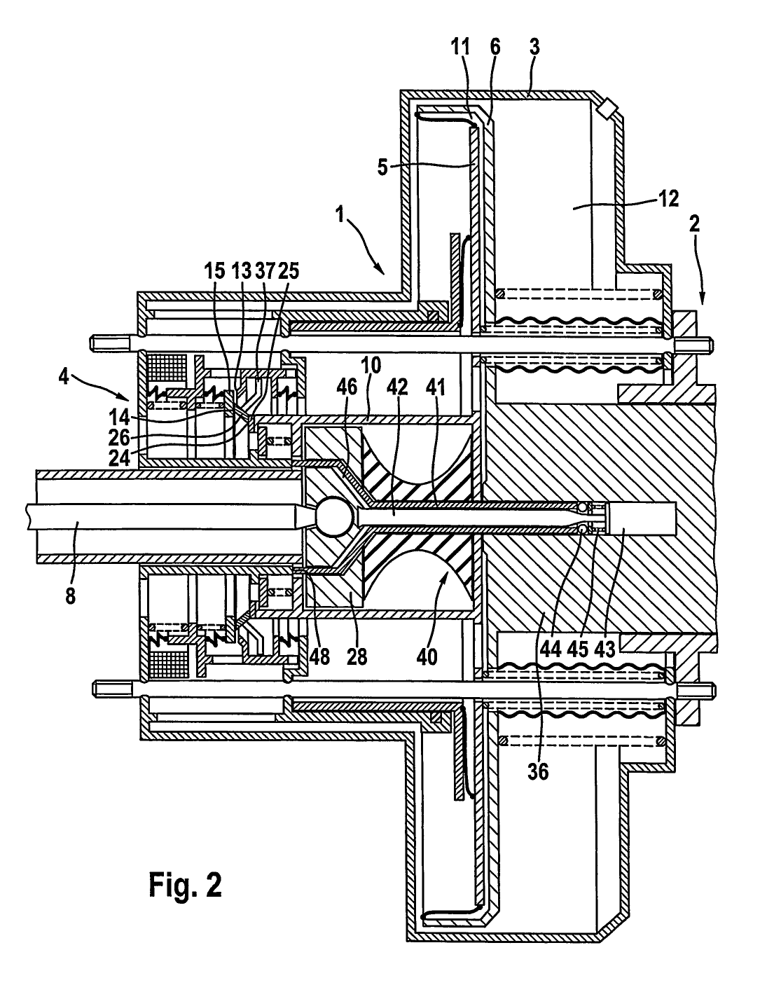

If vacuum supply fails, it is necessary to disable the brake pedal travel simulation device 9 in terms of effect in order that the actuating travel generated by the driver is not absorbed in the resilient or damping element 29, but actuates the master brake cylinder 2 directly, without assistance of the pneumatic brake booster 1. To this end, a so-called mechanical through grip 40 is provided in FIG. 2, which shall represent only exemplarily the possibility of disabling the brake pedal travel simulation device 9 in terms of effect. In the embodiment illustrated in FIG. 2, the force-transmitting plate 28 includes two channels 46 through which a transmission means 41 extends. Further, a cylindrical recess 43 is provided in the force-transmitting member 36. A tappet 42 is rigidly connected to the force-transmitting plate 28, on the one hand, and projects into the cylindrical recess 43 in the force-transmitting member 36, on the other hand. At the right-hand end of the tappet 42 in FIG. 2, balls 44 and a spring 45 are arranged, urging the balls against the transmission means 41 mentioned before. When actuation of the pneumatic brake booster 1 takes place and the vacuum supply fails, then the piston rod 8 and the cylindrical component 10 will displace to the right in the drawing. As vacuum is unavailable, the two movable walls 5, 6 will not move away from each other but displace jointly to the right. The transmission means 41 is continuously urged against a support 48 when the cylindrical component 10 is displaced due to the effect of the spring 45. Due to the relative displacement of the transmission means towards the tappet 42 connected to the force-transmitting plate 28, the above-mentioned balls 44 are urged against two slopes on the tappet 42 until they are finally wedged and a relative movement between the force-transmitting member 36 and the force-transmitting plate 28 is prevented. Subsequently, the master brake cylinder 2 is actuated directly by the driver by way of the brake pedal (not shown).

Further, the embodiment shown in FIG. 2 includes an additional atmospheric sealing seat 24 which cooperates with an additional annular valve member 25. The purpose of this additional atmospheric sealing seat 24 is to further improve dynamics. In the event of a quick actuation of the piston rod 8 and, thus, the control group 4, the additional atmospheric sealing seat 24 is opened, and the working chamber 11 is aerated more quickly, whereupon a quicker reaction of the second movable wall 6 and, thus, a quicker pressure buildup in the master brake cylinder 2 takes place. To realize the additional atmospheric sealing seat 24, a ring 26 is provided which is arranged between the cylindrical component 10 and the valve member 15 and, on the one hand, carries the atmospheric sealing seat 14 which cooperates with the valve member 15 and, on the other hand, carries the additional atmospheric sealing seat 24 which cooperates with the additional valve member 25. The additional valve member 25 is connected to the cylindrical component 10. The ring 26 mentioned before is designed in such a fashion that the difference in pressure between the vacuum in the booster housing 3 and the atmospheric pressure of the ambience acts on the ring 26 and presses it against the additional valve member 25. Besides, the ring 26 includes arms 37 which guide the ring 26 and limit its movement to the right in the drawing, without impairing the pneumatic connection between the control group 4 and the working chamber 11.

In the embodiment shown in FIG. 2, the frictional connection between the atmospheric sealing seat 14 and the first movable wall 5 takes place by way of the ring 26 and the additional atmospheric sealing seat 24 and, accordingly, the movement of the additional atmospheric sealing seat 24 is coupled to the movement of the first movable wall 5.

It is advantageous in the entire arrangement that no noticeable reactions on the brake pedal (not shown) develop, for example, when anti-lock control is carried out.

1-17. (canceled)

18. An actuation unit for a hydraulic vehicle brake system comprising:
a master brake cylinder (2);
a booster housing having first moveable (5) and a second movable wall (6);
a pneumatic brake booster (1) in the booster housing and connected downstream of the pneumatic brake booster; and
a control group (4) comprising a vacuum sealing seat (13), an atmospheric sealing seat (14), and a valve member cooperating with the sealing seats (13,14), wherein the first movable wall (5) and the second movable wall (6) being in a force-transmitting connection to a piston of the master brake cylinder (2), with the movable walls delimiting a working chamber (11) which can be evacuated or aerated by the control group (4) and the vacuum sealing seat (13) is in operative engagement with the booster housing (3), while the atmospheric sealing seat (14) is in operative engagement with the first movable wall (5).

19. An actuation unit according to claim 18, wherein a frictional connection between the vacuum sealing seat (13) and the booster housing (3) is established by means comprising at least one stop (21) and an electrically controllable stroke actuator (7).

20. An actuation unit according to claim 19, wherein the frictional connection between the atmospheric sealing seat (14) and the first movable wall (5) is established by a fixed coupling or a direct mechanical contact of the mentioned components.

21. An actuation unit according to claim 19, wherein the frictional connection between the atmospheric sealing seat (14) and the first movable wall (5) occurs by way of the additional sealing seat (24).

22. An actuation unit according to claim 18, wherein an additional atmospheric sealing seat (24) is provided which interacts with an additional valve member (25) and becomes active when the control group (4) is quickly actuated.

23. An actuation unit according to claim 18, wherein the movement of the vacuum sealing seat (13) is coupled to the movement of an armature (17) of the electrically controllable stroke actuator (7) which, in the event of an actuation stroke, closes the vacuum sealing seat (13) by abutment on the valve member (15) and opens the atmospheric sealing seat (14) by lifting the valve member (15).

24. An actuation unit according to claim 23, wherein the electrically controllable stroke actuator (7) is arranged in an immovable way relative to the booster housing (3).

25. An actuation unit according to claim 18, wherein the movement of at least one atmospheric sealing seat (14, 24) is coupled to the movement of the first movable wall (5).

26. An actuation unit according to claim 18, wherein a brake pedal travel simulation device (9) is provided, comprising at least one of a resilient, damping or frictional elements.

27. An actuation unit according to claim 26, wherein the brake pedal travel simulation device (9) is accommodated in a cylindrical component (10) which is connected to the first movable wall (5) and carries one of the atmospheric sealing seats (14, 24).

28. An actuation unit according to claim 26, wherein the resilient, damping or frictional elements (29) are arranged between the first movable wall (5) and a piston rod (8) actuating the control group (4) in terms of force transmission.

29. An actuation unit according to claim 26, wherein the brake pedal travel simulation device (9) is disabled in terms of effect.

30. An actuation unit according to claim 29, wherein the brake pedal travel simulation device (9) is disabled in terms of effect depending on the travel of the first movable wall (5) relative to the booster housing (3).

31. An actuation unit according to claim 18, wherein a pneumatic vacuum chamber (12) is provided in the booster housing (3), extending into the area of the control group (4) and being connectible to the working chamber (11).

32. An actuation unit according to claim 18, wherein one or more pneumatic sealants are provided between the booster housing (3) and the movable parts of the control group (4) or between these, the sealants being configured as pleated bellows (30) or hose collars.

33. An actuation unit according to claim 18, wherein at least two tensile-force transmitting elements (18) are provided which extend through the booster housing (3) and are used to attach the master brake cylinder (2) to the booster housing (3) and to mount the actuation unit on a splashboard of the vehicle.

34. An actuation unit according to claim 18, wherein a provision of a disengaging sleeve (19) which is slidingly arranged in the booster housing (3) in a pneumatically seal-tight manner and is connected to the first movable wall (5) by way of a rolling diaphragm (20).
